(19) United States
(12) Patent Application Publication
(10) Pub. No.: US 2008/0126455 A1
(43) Pub. Date: May 29, 2008

(54) Methods of protecting management frames exchanged between two wireless equipments, and of receiving and transmitting such frames, computer programs, and data media containing said computer programs

(75) Inventors: Stanislas Francfort, Evrecy (FR); Jerome Razniewski, Issy Les Moulineaux (FR); Roland Duffau, Paris (FR)

Correspondence Address: OLIFF & BERRIDGE, PLC, P.O. BOX 320850, ALEXANDRIA, VA, 22320-4850, US

(73) Assignee: FRANCE TELECOM, Paris (FR)

(21) Appl. No.: 11/483,984

(22) Filed: Jul. 11, 2006

(51) Int. Cl. G06F 7/48

(52) U.S. Cl. 708/200

(57) ABSTRACT

The management frame protection method comprises, for the first management frame (7, 8, 9, 10) sent by a first equipment and received by a second equipment, a step of inserting in said first management frame (7, 8, 9, 10) a parameter f(X₀) that is an image of a predetermined numerical value X₀ as obtained by a mathematical function f that is difficult to invert and that is known to both equipments, and for each k^{th} management frame (7, 8, 9, 10) sent by the first equipment and received by the second equipment:
a step of inserting in said k^{th} management frame (7, 8, 9, 10) a parameter f(Xₖ) that is the image of a numerical value Xₖ as obtained by the mathematical function f, and a numerical value Xₖ₋₁ that was used to determine a parameter f(Xₖ₋₁) inserted in a (k−1)^{th} management frame (3, 4, 5, 6); and
a step of the second equipment comparing an image of the numerical value Xₖ₋₁ as obtained by the function f as received in the k^{th} management frame (7, 8, 9, 10) with the parameter f(Xₖ₋₁) received in the k−1^{th} management frame (3, 4, 5, 6).

The present invention relates to a method of protecting management frames exchanged between two wireless equipments, in particular for Wi-Fi frames. The invention also relates to a method of transmitting management frames and to a method of receiving such frames, and also to computer programs for implementing said methods, and to data media containing such computer programs.

The invention is involved during interaction between two wireless equipments seeking to connect to each other. These two equipments are often referred to as a “client” and as an “access point”. The access point may be a terminal, for example when two computers are connecting to each other in order to exchange data, or it may be a gateway enabling a client to access the Internet or a business network.

In the state of the art, the IEEE 802.11 state machine is already known and, for its operation, it requires various management frames.

Amongst these various management frames, there are the following frames:
a beacon frame, which is a broadcast frame transmitted regularly by an access point in order to inform clients of its presence and to send them a set of characteristics specific to the access point (e.g. a network name);
a probe request frame, which is likewise a broadcast frame, seeking to discover access points and transmitted by a client in order to discover what access points are available and to obtain a set of characteristics specific to each of said access points;
a probe response frame which, in response to a probe request, is a unicast frame notifying the client of the presence of an access point and conveying a set of characteristics specific to the access point;
an authentication request frame, which is an unicast frame attempting to authenticate a client with an access point; there are two modes of authentication, one of them is “shared” which requires knowledge of a secret shared between the client and the access point, and the other is “open” which does not require a shared secret;
an authentication response frame, which, in responses to an authentication request, is a unicast notification frame sent to the client by the access point, and containing the result: “success” or “failure”;
an association request frame, which is a unicast frame attempting to associate a client with an access point: this frame conveys information about the client (e.g. available data rates) and the service set identifier (SSID) of the network with which the client wishes to be associated;
an association response frame, which, in response to an association request, is a unicast notification frame sent to the client by the access point, and containing the result: “association accepted” or “association rejected”;
a reassociation request frame, which is a unicast frame attempting to make an association with an access point by a client already associated via a first access point; reassociation occurs when the client moves away from the first access point or when traffic over the first access point becomes too great (a load balancing function);
a reassociation response frame, which, in response to a reassociation request, is a unicast notification frame sent to the client by the access point, and containing the result: “reassociation accepted” or “reassociation rejected”;
a disassociation frame, which is a unicast frame sent either by the client or by the access point to notify the destination equipment that the client is no longer associated; and
a de-authentication frame, which is a unicast frame sent either by the client or by the access point to notify the destination equipment that the client is no longer authenticated.

In known manner, each equipment (client or access point) contains an IEEE 802.11 state machine having the function of representing the instantaneous state of the equipment in the wireless network. Management frame exchanges cause equipments to pass from one state to another and perform overall management of the wireless network.

At present, there is no method enabling unicast management frames to be protected.

In particular, the IEEE 802.11 state machine does not protect the network against usurper management frames sent by an attacker in order to terminate in unauthorized manner a wireless connection between a client and an access point, e.g. by usurping the MAC address of one of those two equipments. Nevertheless, such an attack could lead to a denial of service on equipments using the wireless network.

An object of the invention is to protect the users of wireless networks against usurper management frames.

To this end, the invention provides a method of protecting management frames exchanged between two wireless equipments, the method being characterized in that it comprises, for the first management frame sent by a first equipment and received by a second equipment, a step of inserting in said first management frame a parameter f(X₀) that is an image of a predetermined numerical value X₀ as obtained by means of a mathematical function f that is difficult to invert and that is known to both equipments, and

for each k^{th} management frame sent by the first equipment and received by the second equipment:
a step of inserting in said k^{th} management frame a parameter f(Xₖ) that is the image of a numerical value Xₖ as obtained by the mathematical function f, and a numerical value Xₖ₋₁ that was used to determine a parameter f(Xₖ₋₁) inserted in a (k−1)^{th} management frame; and
a step of the second equipment comparing an image of the numerical value Xₖ₋₁ as obtained by the function f and as received in the k^{th} management frame with the parameter f(Xₖ₋₁) received in the (k−1)^{th} management frame.

A function f is said to be difficult to invert from a space E into a space F when given y in F, it is difficult to find x in E such that y=f(x). As examples of functions that are difficult to invert, mention can be made of hashing functions, e.g. secure hash algorithm 1 (SHA1, cf. IETF Standard RFC3174).

The meaning of the word “difficult” in the above definition should be understood in terms of complexity in calculation, i.e. it is difficult using present-day calculation means and present-day techniques.

By means of the invention, if the client (or the access point) integrates the parameter in any sent management frame, then subsequently if the client (or the access point) integrates the numerical value corresponding to the image of the parameter as inverted by the function f in a management frame sent later than the preceding frame, then the access point (or the client) has proof that it is the same client (or access point) that sends both frames. The subsequent frame can therefore be taken into account. Otherwise, it can be ignored or any appropriate processing can be triggered, e.g. to combat an attacker.

Optionally, each numerical value Xₖ is generated by an algorithm for generating pseudo-random numbers, for example by a Blum Blum Shub (BBS) generator.

In a particular implementation, the parameter is integrated in at least one authentication request frame, authentication response frame, association request frame, association response frame, reassociation request frame, or reassociation response frame, and the numerical value is integrated in at least one disassociation frame or de-authentication frame.

Integrating the numerical value in a de-authentication frame serves to verify that the frame was indeed sent by the equipment that originated an earlier authentication request frame or authentication response frame, and integrating the numerical value in a disassociation frame serves to verify that the frame was indeed sent by the equipment that originated an earlier association request frame, or association response frame, or reassociation request frame, or reassociation response frame, and not by an attacker usurping the identity of the equipment.

Another object of the invention is to protect all successive management frames exchanged between two wireless equipments, even without knowing in advance the number of management frames that are to be exchanged, and to do so with a limited amount of calculation for each pair of frames that are exchanged.

Thus, it is possible to prevent complex attacks making use of the fact that the invention as set out above protects only a second frame subsequent to a first frame, and then possibly a fourth frame subsequent to a third frame, but does not prevent an attacker from sending a usurping frame immediately after the second frame and before the third frame. In particular, in an attack such as the “man-in-the-middle” attack (where the attacker passes itself off as the client with the access point and as the access point with the client), the attacker is to be found between the access point and the client and can intercept all of the communications between those two entities.

To do this, in a particular implementation, the above-described steps are reiterated, assuming that each new management frame, subsequent to a given management frame, is a second management frame, and the given management frame is a first management frame.

In this way, it becomes impossible for an attacker to cause an equipment to take account of a usurping association request frame that is interposed, for example, between an authentication response and an association request.

In this implementation, an access point does not accept an association request or a reassociation request that does not include the expected numerical value.

Furthermore, on certain access points, an association request or a reassociation request coming from an already-associated client causes said client to be deassociated. Consequently, such a request coming from an attacker leads to a denial of service for the client. The present implementation provides protection against such attacks.

In a first variant of this implement, the following are both integrated in the k^{th} management frame:
a parameter f(Xₖ) where Xₖ is a numerical value; and
a numerical value Xₖ₋₁.

In this manner, it is possible to verify:
that the k^{th} management frame is sent by the same equipment as sent the (k−1)^{th} management frame containing f(Xₖ₋₁) and Xₖ₋₂; and
that the (k+1)^{th} management frame which ought to contain f(Xₖ₊₁) and Xₖ was sent by the same equipment as sent the k^{th} management frame.

It is thus possible to protect all successive frames.

In a second variant of this implementation, pₖ is integrated in the k^{th} management frame, such that:

pₖ=f^{N-k}(X₀)

where X₀ is a constant and N is an integer greater than the maximum number of successive frames to be protected, such that N−k remains a positive integer.

In this variant, pₖ serves:
firstly as an expected numerical value, serving to verify that the k^{th} frame was sent by the same equipment as the (k−1)^{th} frame which knows the parameter pₖ₋₁=f^{N-(k-1)}(X₀), i.e. f o f^{N-k}(X₀), i.e. f(pₖ); and
subsequently as a parameter, serves to verify that the (k+1)^{th} frame, which ought to contain the numerical value pₖ₊₁=f^{N-(k+1)}(X₀), i.e. f⁻¹ o f^{N-k}(X₀), i.e. f⁻¹(pₖ), was indeed sent by the same equipment as sent the k^{th} frame.

It is thus also possible to protect successive frames.

According to other characteristics of the invention:
the second management frame is consecutive to the first management frame; and
the new management frame is consecutive to the given management frame.

The invention also provides a method of receiving management frames by a wireless equipment, characterized in that, for a mathematical function f that is difficult to invert and that is known to the equipment:
a parameter, an image of a numerical value as obtained by the function f, is extracted from a first received management frame;
a numerical value is extracted from a second received management frame subsequent to the first management frame; and
the image of the numerical value received in the second management frame and as obtained by the function f is compared with the parameter received in the first management frame.

The invention also provides a method of sending management frames by a wireless equipment, the method being characterized in that, for a mathematical function f that is difficult to invert and that is known to the equipment:
a parameter that is an image of a numerical value as obtained by the function f is integrated in a first transmitted management frame; and
a numerical value is integrated in a second management frame that is transmitted later than the first management frame.

The invention also provides computer programs for receiving management frames on a wireless equipment and for sending management frames from a wireless equipment, the programs being characterized in that each of them comprises a series of instructions for implementing the corresponding method.

The invention also provides a data medium containing a computer program for receiving management frames on a wireless equipment and a data medium containing a computer program for sending management frames from a wireless equipment.

The invention can be better understood on reading the following description, given purely by way of example, and made with reference to the accompanying drawings, in which:

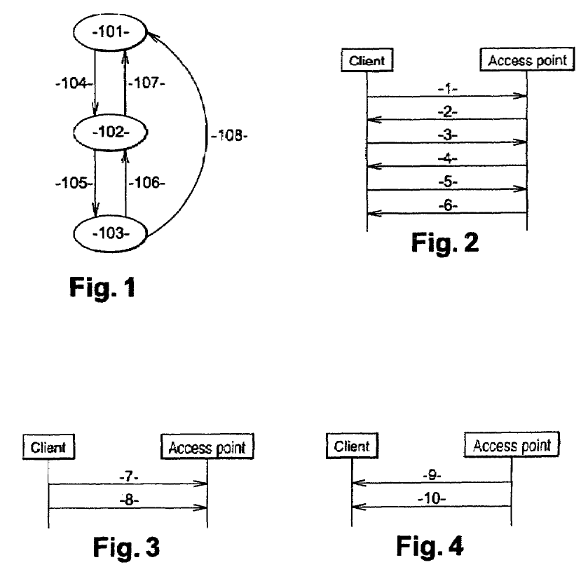

FIG. 1 is a diagram showing state transitions in the IEEE 802.11 state machine in the prior art;

FIG. 2 is a diagram showing the exchanges of frames between a client and an access point using a method constituting a first implementation of the invention;

FIG. 3 is a diagram showing the exchanges of disassociation and de-authentication frames from a client using the same method as in FIG. 2; and

FIG. 4 is a diagram showing the exchanges of disassociation and de-authentication frames from an access point using the same method as in FIG. 2.

The prior art IEEE 802.11 state machine, shown in FIG. 1, has three states:
state 101: the equipment is neither authenticated nor associated;
state 102: the equipment is authenticated but not associated; and
state 103: the equipment is authenticated and associated.

Such a state machine is present in each wireless equipment, and in particular in a client and in an access point.

In order to enable the access point and the client to make the transition 104 from state 101 to state 102, the client sends an authentication equipment frame to the access point. If the authentication equipment is accepted by the access point, then the access point returns an authentication response frame to the client containing the result “success”, and both the access point and the client pass to state 102.

Similarly, in order for the access point and the client to perform the transition 105 from state 102 to state 103, the client sends an association request frame (or a reassociation request frame). If the association request frame is accepted by the access point, then the access point sends an association response frame to the client containing the result “association accepted” (or “reassociation accepted”), and both the access point and the client pass to state 103.

Conversely, when the client or the access point seeks to make the reverse transition 106 going back to state 102, it sends a disassociation frame.

When the client or the access point seeks to make the transition 107 going back to state 101, it sends a de-authentication frame.

The client or the access point may also perform the transition 108 from state 103 to state 101 directly by sending solely a de-authentication frame while it is in state 103.

The invention proposes using certain parameters of management frames in order to act in simple and effective manner to ensure that the management frames do indeed originate from the expected equipment (access point or client) and not from a usurper equipment.

FIG. 2 shows the frames exchanged during a connection by a client to an access point in a first implementation:

1) The client sends a probe request specifying the enhanced service set identifier (ESSID) of the network to which the client wishes to be connected.

2) The access point sends a probe response frame to the client. The client then generates in pseudo-random manner a numerical value Xₐᵤₜₕ, and then calculates f(Xₐᵤₜₕ)

3) The client sends an authentication request frame to the access point with a parameter f(Xₐᵤₜₕ). The access point receives this frame, associates the parameter f(Xₐᵤₜₕ) with the connection, and in pseudo-random manner generates a numerical value Yₐᵤₜₕ, and then calculates f(Yₐᵤₜₕ).

4) The access point sends an authentication response frame to the client containing the parameter f(Yₐᵤₜₕ). The client receives this frame, associates the parameter f(Yₐᵤₜₕ) with the connection, and generates in pseudo-random manner a numerical value Xₐₛₛ, and then calculates f(Xₐₛₛ).

5) The client then sends an association request frame to the access point containing the parameter f(Xₐₛₛ). The access point receives this frame, associates the parameter f(Xₐₛₛ) with this connection, and in pseudo-random manner generates a numerical value Yₐₛₛ, and then calculates f(Yₐₛₛ).

6) The access point sends an association response frame to the client containing the parameter f(Yₐₛₛ). The client associates the parameter f(Yₐₛₛ) with the connection.

When the client seeks to disconnect, after being connected using the above method, the client performs the following steps, as shown in FIG. 3:

7) To disassociate, the client includes the numerical value Xₐₛₛ in the disassociation frame.

8) To de-authenticate, the client integrates the numerical value Xₐᵤₜₕ in the de-authentication frame.

This enables the access point to verify the origin of the de-authentication and disassociation frames respectively by comparing the parameter received in step 5) with the image of the numerical value as obtained by f and as received in step 7), or the parameter received in step 3) with the image received in step 8).

In this way, by applying the method to authentication request or response frames, to association request or response frames, or to reassociation request or response frames, and to de-authentication or disassociation frames, it is possible to protect de-authentication or disassociation frames.

Similarly, if the client receives a disassociation request frame (or a de-authentication frame) containing as its source the MAC address of the access point and as its destination address its own MAC address, it then verifies that the frame contains a suitably completed field Yₐₛₛ (or Yₐᵤₜₕ):
If the field Yₐₛₛ (or Yₐᵤₜₕ) is completed, then it calculates f(Yₐₛₛ) (or f(Yₐᵤₜₕ)) and verifies that f(Yₐₛₛ) (or f(Yₐᵤₜₕ) as calculated from the field corresponds to the f(Yₐₛₛ) (or f(Yₐᵤₜₕ)) associated with the connection:
if so, then it accepts disassociation (or de-authentication) and returns to a state in which it is authenticated but not associated (or to a state in which it is neither associated nor authenticated);
else it does not take the frame into account.
Else, the field Yₐₛₛ (or Yₐᵤₜₕ) is empty. Under such circumstances, the client verifies whether it has in memory an f(Yₐₛₛ) (or an f(Yₐᵤₜₕ)) associated with the connection:
if so, then the frame is not taken into account since it is very likely that the frame comes from an attacker seeking to send disassociation (or de-authentication) frames to the client by usurping the identity of the access point but unaware of Yₐₛₛ (or Yₐᵤₜₕ);
else, this means that it has agreed with the access point not to implement the protection method of the invention, and so the disassociation (or de-authentication) is accepted.

It should be observed that de-authentication or disassociation frames are protected for the access point in the same manner as for the client.

Thus, when the access point seeks to disconnect, it performs the following steps, shown in FIG. 4:

9) To disassociate, it integrates the numerical value Yₐₛₛ in the disassociation frame.

10) To de-authenticate, it integrates the numerical value Yₐᵤₜₕ in the de-authentication frame.

This enables the client to verify the origin of the de-authentication or disassociation frame respectively by comparing the parameter received in step 6) with the image of the numerical value as obtained by f with the value received in step 9), or the parameter received in step 4) with the image of the numerical value as obtained by f with the value received in step 10).

Likewise, if the access point receives a disassociation request frame (or a de-authentication request frame) containing as its source address the MAC address of the client and as its destination address its own MAC address, then it verifies whether the frame contains a properly completed field Xₐₛₛ (or Xₐᵤₜₕ):
If the field Xₐₛₛ (or Xₐᵤₜₕ) is completed, then it calculates f(Xₐₛₛ) (or f(Xₐᵤₜₕ)) and verifies that f(Xₐₛₛ) (or f(Xₐᵤₜₕ)) as calculated from said field corresponds to the f(Xₐₛₛ) (or f(Xₐᵤₜₕ)) associated with the connection:
if so, then disassociation (or de-authentication) is accepted and it passes to a state in which it is authenticated but not associated (or to a state in which it is neither associated nor authenticated);
else the frame is not taken into account.
Else, the field Xₐₛₛ (or Xₐᵤₜₕ) is empty. Under such circumstances, the access point verifies whether it possesses in memory an f(Xₐₛₛ) (or f(Xₐᵤₜₕ)) associated with the connection:
if so, then the frame is not taken into account since it is very likely that it comes from an attacker attempting to send disassociation (or de-authentication) frames to the access point by usurping the identity of the client, but not knowing Xₐₛₛ (or Xₐᵤₜₕ);
else, this means that it has agreed with the client not to implement the protection method of the invention, so the disassociation (or de-authentication) is accepted.

Thus, the origin of a de-authentication frame or a disassociation frame is indeed verified.

Nevertheless, as already emphasized, in this implementation, only de-authentication and disassociation frames are protected.

In a second implementation, the protection method protects not only de-authentication or disassociation frames, but also authentication request or response frames, association request or response frames, and reassociation request or response frames, e.g. against the denial of service that an attacker might attempt by sending authentication, association, or reassociation frames.

To do this, in a first variant, a numerical value Xₙ₋₁ is associated with the parameter f(Xₙ) when sending any management frame, the numerical value Xₙ₋₁ corresponding to sending the preceding management frame and the parameter f(Xₙ) corresponding to the numerical value Xₙ that is to be associated on sending the next management frame.

If there is no yet an ongoing connection, as happens on initial authentication or on reassociation, then the numerical value Xₙ₋₁ is replaced by an arbitrary numerical value, e.g. zero.

Thus, when a client (or an access point) sends frames to an access point (or a client) using the protection method of the invention in the second implementation, it can be found in one of the following circumstances, depending on the management frame sent:
for a probe request frame (or a probe response frame), there is no change;
for an authentication request frame (or an authentication response frame), a pair (0, f(X₁)) is sent;
for each following frame, a respective pair (Xₙ₋₁, f(Xₙ)) is sent, where each Xₙ₋₁ corresponds to the f(Xₙ₋₁) sent in the preceding frame.

When the client (or the access point) receives a management frame, it can be found in one of the following circumstances, depending on the received management frame:
for the probe response frame (or probe request frame), there is no change;
for the initial authentication response frame (or the initial authentication request frame), the received f(X₁) is associated with the connection;
for each following frame, it is verified that Xₙ₋₁ corresponds to the f(Xₙ₋₁) received in the preceding management frame:
   if Xₙ₋₁ does not correspond, then the frame is rejected;
   if Xₙ₋₁ does correspond, then the frame is accepted and the new f(Xₙ) is associated with the connection.

In general, this amounts to reiterating the first implementation, considering each new management frame subsequent to a given management frame as a second management frame, and the given management frame as a first management frame.

From a practical point of view, the second implementation requires the generated pair (Xₙ₋₁, f(Xₙ)) to be stored in a long-term memory prior to sending the management frame. The equipment must be capable of associating itself with another equipment with which it has already had exchanges, even in the event of the machine accidentally being turned off.

It is also possible to make use of an activity timeout at the access point. Thus, if a client is inactive for a determined length of time, then the access point can automatically delete that client from its association table together with the associated (Xₙ₋₁, f(Xₙ)). Subsequently, the client can again associate itself with the access point by sending (0, f(Xₙ)).

In this first variant, the chaining of successive management frames is ensured by the pairs (Xₙ₋₁, f(Xₙ)).

In a second variant, this chaining is provided by using the parameter of one frame as the expected numerical value in a subsequent frame, i.e. integrating pₖ=f^{N-k}(X) in a k^{th} frame.

This avoids integrating the pairs (Xₙ₋₁, f(Xₙ)) in the frames, but it makes it necessary to know in advance the maximum number of successive frames that are going to need to be protected, and it also requires the numerical values f^{N}(X), f^{N-1}(x), . . . , f^{N-k}(X), . . . , f(X) to be conserved.

There also exist other variants of the two implementations using the method of the invention.

It is possible to implement protection solely for the client or solely for the access point. Furthermore, it is possible to seek to protect only some de-authentication or disassociation frames, for example by integrating the parameter in association frames only (or in authentication frames only). Numerous combinations are thus possible.

In another aspect of the invention, the reassociation frames are also protected.

The method during the reassociation stage then takes place as follows:
if the client has not used the invention during association, then a normal reassociation stage is begun in application of the prior art;
if the client has previously been associated by using the method of the invention, then the client sends a reassociation request frame to a new access point with a completed field f(Xₐₛₛ,); the access point then verifies whether the client is already associated therewith:
   a) if it already knows the client, i.e. if the access point already possesses an established association with the MAC address of the client, then the frame is not taken into account;
   b) else, this is a new client, so the access point goes to above-described steps 5) and 6): the access point recovers the field f(Xₐₛₛ,) and then sends an association response to the client including therein the field f(Yₐₛₛ,) and associates f(Xₐₛₛ,) with the connected user. The client, on receiving the frame, associates the received f(Yₐₛₛ,) with the connection.

Amongst the advantages of the invention, it should be observed that the management frames used are management frames of the IEEE 802.11 Standard. This Standard allows for optional so-called “tagged” parameters to be added in the management frames, thus making it possible to specify parameters such as X and f(X).

Thus, the method can easily be integrated by Wi-Fi access points and clients since only a few parameters are added in some of the management frames of the IEEE 802.11 state machine. It is thus possible to activate the invention on presently-existing equipment merely by adding software.

The invention is not limited to the implementations described above, but on the contrary covers any variant using equivalent means to reproduce its essential characteristics.

In particular, the present description is based on the IEEE 802.11 Standard. Nevertheless, the invention also applies in non-limiting manner to the WPA and 802.11i Standards, in which the authentication and association stages are the same and the problem of lack of protection for management frames is likewise present.

1. A method of protecting management frames exchanged between two wireless equipments, the method being characterized in that it comprises, for the first management frame sent by a first equipment and received by a second equipment, a step of inserting in said first management frame a parameter f(X₀) that is an image of a predetermined numerical value X₀ as obtained by means of a mathematical function f that is difficult to invert and that is known to both equipments, and
for each k^{th} management frame sent by the first equipment and received by the second equipment:
a step of inserting in said k^{th} management frame a parameter f(Xₖ) that is the image of a numerical value Xₖ as obtained by the mathematical function f, and a numerical value Xₖ₋₁ that was used to determine a parameter f(Xₖ₋₁) inserted in a (k−1)^{th} management frame; and
a step of the second equipment comparing an image of the numerical value Xₖ₋₁ as obtained by the function f and as received in the k^{th} management frame with the parameter f(Xₖ₋₁) received in the (k−1)^{th} management frame.

2. A protection method according to claim 1, in which each numerical value Xₖ is generated by an algorithm for generating pseudo-random numbers.

3. A protection method according to claim 1, characterized in that the function f that is difficult to invert is a hashing function.

4. A method of sending management frames by a wireless equipment, the method being characterized in that for a mathematical function f that is difficult to invert and that is known to the equipment, the method comprises for each k^{th} management frame sent by the wireless equipment:
a step of inserting, in said k^{th} management frame, a parameter f(Xₖ) that is an image of a numerical value Xₖ as obtained by the mathematical function f; and
a step of inserting in said k^{th} management frame, a numerical value Xₖ₋₁ that was used to determine a parameter f(Xₖ₋₁) that was inserted in a (k−1)^{th} management frame.

5. A computer program for sending management frames from a wireless equipment, characterized in that it comprises a series of instructions for implementing the method according to claim 4.

6. A data medium containing a computer program according to claim 5.

7. A protection method according to claim 2, characterized in that the function f that is difficult to invert is a hashing function.
